(19) United States
(12) Patent Application Publication
(10) Pub. No.: US 2026/0216738 A1
(43) Pub. Date: Jul. 30, 2026

(54) METHOD AND SYSTEM FOR TREATING FLUID

(71) Applicant: Vortex AG, Vaduz (LI)

(72) Inventors: Srapyan Oganes SRAPYAN, Madrid (ES); Nikolaevich Nikolai NOVIKOV, Ribinsk (RU); Waldemar WEIMER, Au (CH)

(73) Assignee: Vortex AG, Vaduz (LI)

(21) Appl. No.: 19/144,629

(22) PCT Filed: Dec. 28, 2023
(86) PCT No.: PCT/IB2023/063315

§ 371 Date: Jun. 30, 2025

(30) Foreign Application Priority Data
Dec. 30, 2022 (ES) P202231126

(51) Int. Cl. B04C 5/081; B01D 17/02; B01D 19/00; B01D 21/24; B01D 21/26; B01D 21/30; B04C 5/04; B04C 5/16; B04C 11/00; C02F 1/38

(52) U.S. Cl. CPC B04C 5/081; B01D 17/0217; B01D 19/0057; B01D 21/245; B01D 21/267; B01D 21/302; B04C 5/04; B04C 5/16; B04C 11/00; C02F 1/38; C02F 2201/005; C02F 2209/40; C02F 2303/04

(57) ABSTRACT

A fluid treatment system comprises a swirling apparatus which forms a helical flow, induces turbulence and cavitation, and centrifugally drifts foreign material contained in the fluid toward a periphery of the helical flow. A tapered hollow structure separates the helical flow into an inner flow within the hollow structure and a peripheral flow outside the hollow structure, wherein an amount of the foreign material is higher in the peripheral flow than in the inner flow. A first outlet discharges the inner flow, and a second outlet discharges the peripheral flow.

### RELATED APPLICATION

This application claims the benefit of priority of Spanish Patent Application No. P202231126 filed on Dec. 30, 2022, the contents of which are incorporated herein by reference in their entirety.

### FIELD AND BACKGROUND OF THE INVENTION

The present invention, in some embodiments thereof, relates to fluid dynamics and, more particularly, but not exclusively, to a method and system for treating fluid, such as, but not limited to, water.

Water is the vital elixir supporting life on Earth. The importance of water transcends mere sustenance, as it is the linchpin of ecosystems, the essence of existence, and the bedrock of civilizations. It is the lifeblood of agriculture, facilitating the growth of crops, and it also serves as a vital resource in manufacturing processes.

The serene flow of water bodies is disrupted by a multitude of pollutants. Industrial effluents laden with chemicals, agricultural runoff carrying pesticides and fertilizers, urban debris washed by stormwater, and inadequate waste disposal all converge to tarnish the purity of water sources. Oil spills, deliberate or accidental, stand as a testament to the fragility of aquatic ecosystems.

The ramifications of this pollution are dire and far-reaching. Aquatic ecosystems, once teeming with life, face devastation. The delicate balance disrupted by pollutants heralds the decline of species, the degradation of habitats, and the ominous threat of eutrophication, suffocating water bodies and depriving them of oxygen. Equally concerning are the human health hazards. Contaminated water sources serve as breeding grounds for waterborne diseases, posing severe risks to human health. Communities relying on polluted waterways for sustenance and livelihoods find themselves grappling with economic losses, impacting fishing industries, agriculture, and tourism.

Water treatment is currently a process involving different types of operations, whereby physical, chemical, physical-chemical or biological treatments are used to eliminate or reduce water pollution or undesirable characteristics.

ES 2 567 529 A1 describes a seawater distillation system using a spiral turbine, which drives a conical screw air injector with decreasing pitch; air compression that vaporizes seawater by gaseous heating, after which the expansion of the gas causes the precipitation of the distilled vapor as pure water. In addition, the system recovers the pneumatic and hydraulic energy associated with this purifying process by using the same turbines, inserted respectively in the injection pneumatic circuit and the hydraulic circuit obtained from the precipitation of the generated water vapor, for use for any job.

ES 1 023 385 U outlines an improved water purifying device, including a tank for receiving water from the network or another source, which, after passing through filters or cartridges and being cooled by a cooling coil, is then sent by means of, for example, a pressure pump to a tank of purified water for consumption. Filtered water is passed through porous plastic membranes or other materials capable of carrying out inverse osmosis in order to perform a second purification of the water with high efficiency. The set is arranged in a cabinet with limited access, preferably locked, with an opening on the front through which successive glasses fall, coming from, for example, a column stack, and are filled synchronously from the purified water tank by inserting coins into the set's conventional coin slot.

ES 1 268 870 U describes a water purifying device that includes an ozonized water generating unit and an interconnected ozonized water distribution unit. The ozonized water distribution unit includes an ozonized water circuit intended to be fed with ozonized water from the ozonized water generating unit to feed a washing machine or several washing machines configured so as not to require the supply of ozonized water at the same time; a solenoid valve, controlled through a relay, inserted into the ozonized water circuit; a first electrical power supply circuit for controlling the relay, with the first electrical power supply circuit connected to an external controller device integrated into the at least one washing machine; a washing additives tank connected by ducts to the ozonized water circuit through a washing additives dosing pump; a second electrical power supply circuit for controlling the dosing pump, with the second electrical power supply circuit connected to an external controller device integrated into the at least one washing machine.

### SUMMARY OF THE INVENTION

According to some embodiments of the invention the present invention there is provided a system for treating a fluid containing foreign material. The system comprises a swirling apparatus configured to accelerate the fluid to form a helical flow of the fluid, to induce fluid turbulence and cavitation, and to centrifugally drift the foreign material toward a periphery of the helical flow. The system also comprises a tapered hollow structure configured for separating the helical flow into an inner flow within the hollow structure and a peripheral flow outside the hollow structure, wherein an amount of the foreign material is higher in the peripheral flow than in the inner flow. The system further comprises first outlet configured to discharge the inner flow, and a second outlet configured to discharge the peripheral flow.

According to some embodiments of the invention the swirling apparatus is configured to impart planar acceleration.

According to some embodiments of the invention the system comprises a tubular structure, wherein the swirling apparatus is arranged to feed the helical flow of the fluid into the tubular structure, and wherein at least one of the flows generates a resonance in the tubular structure.

According to some embodiments of the invention the system comprises an inlet arranged to guide the fluid from a fluid source to the swirling apparatus along a direction generally perpendicular to a longitudinal axis of the tubular structure.

According to some embodiments of the invention the hollow structure is at least partially closed at a distal end thereof, forcing a return flow of the fluid toward the swirling apparatus and opposite to the peripheral flow, wherein the first and the second outlets are at opposite sides of the swirling apparatus.

According to some embodiments of the invention the system comprises a controllable valve for the at least partially closure of the distal end.

According to some embodiments of the invention the system comprises a controller having a circuit configured for controlling the valve based on a ratio between flow rates of the inner and the peripheral flows.

According to some embodiments of the invention the second outlet is circumferential and co-planar with a distal end of the hollow structure.

According to some embodiments of the invention the tapered hollow structure is stepwise tapered.

According to some embodiments of the invention the tapered hollow structure comprises a set of hollow casings arranged telescopically with open channels between adjacent casings establishing fluid communications between the inner and the peripheral flows, so as to guide a peripheral portion of the inner flow via the channels to join the peripheral flow.

According to some embodiments of the invention the system comprises a container wherein the second outlet is configured to discharge the peripheral flow is into the container.

According to some embodiments of the invention the system comprises a container outlet for discharging the fluid out of the container.

According to an aspect of some embodiments of the present invention there is provided a method of treating a fluid containing foreign material. The method comprises feeding the fluid containing foreign material into a fluid treatment system and receiving from the fluid treatment system two separate fluid flows containing unequal amounts of the foreign material, wherein the fluid treatment system comprises the system as delineated above and optionally and preferably as further detailed below.

According to an aspect of some embodiments of the present invention there is provided a method of treating a fluid containing foreign material. The method comprises: by a swirling apparatus, accelerating the fluid to form a helical flow of the fluid, to induce fluid turbulence and cavitation, and to centrifugally drift the foreign material toward a periphery of the helical flow; by a tapered hollow structure, separating the helical flow into an inner flow within the hollow structure and a peripheral flow outside the hollow structure, wherein an amount of the foreign material is higher in the peripheral flow than in the inner flow; and discharging the inner flow separately from the peripheral flow.

According to some embodiments of the invention the accelerating by the swirling apparatus is planar.

According to some embodiments of the invention the flows are formed within a tubular structure, wherein at least one of the flows generates a resonance in the tubular structure.

According to some embodiments of the invention the method comprises guiding the fluid from a fluid source to the swirling apparatus along a direction generally perpendicular to a longitudinal axis of the tubular structure.

According to some embodiments of the invention the hollow structure is at least partially closed at a distal end thereof, forcing a return flow of the fluid toward the swirling apparatus and opposite to the peripheral flow, wherein the discharge of the inner and the peripheral flows is at opposite sides of the swirling apparatus.

According to some embodiments of the invention the hollow structure is at least partially closed at the distal end by a controllable valve, and the method comprises controlling the valve based on a ratio between flow rates of the inner and the peripheral flows.

According to some embodiments of the invention the discharge of the peripheral flow is circumferential and co-planar with the distal end.

According to some embodiments of the invention the tapered hollow structure comprises a set of hollow casings arranged telescopically with open channels between adjacent casings of the set establishing fluid communications between the inner and the peripheral flows, wherein the method comprises guiding a peripheral portion of the inner flow via the channels to join the peripheral flow.

According to some embodiments of the invention the hollow casings are shaped as non-tapered cylinders.

According to some embodiments of the invention the discharge of the peripheral flow is into a container.

According to some embodiments of the invention the method comprises discharging the fluid out of the container.

According to some embodiments of the invention the fluid comprises water.

According to some embodiments of the invention the fluid and foreign material form wastewater.

According to some embodiments of the invention the foreign material comprises a material in a solid phase.

According to some embodiments of the invention the foreign material comprises components in a liquid phase.

According to some embodiments of the invention the foreign material comprises components in a gaseous phase.

According to some embodiments of the invention the fluid is liquid and the foreign material comprises a material forming an emulsion with the liquid.

According to some embodiments of the invention the fluid is liquid and the foreign material comprises gas molecules dissolved in the liquid.

According to some embodiments of the invention the foreign material comprises an inorganic material.

According to some embodiments of the invention the foreign material comprises an organic material.

According to some embodiments of the invention the foreign material comprises a biological material.

According to an aspect of some embodiments of the present invention there is provided a method of separating water. The method comprises generating a flow in the water while inducing cavitation therein, thereby providing an ion-enriched water flow comprising at least hydrogen ions and hydroxide ions. The method also comprises separating the ion-enriched water flow into a first secondary water flow physically separated from a second secondary water flow, wherein an amount of hydrogen ions is higher in the first secondary water flow than in the second secondary water flow, and wherein an amount of hydroxide ions is higher in the second secondary water flow than in the first secondary water flow.

According to some embodiments of the invention the generating the flow comprises generating a three-dimensional vortex.

According to some embodiments of the invention the second secondary flow is peripheral to the first secondary flow.

According to some embodiments of the invention the method is executed for changing a color or transparency of a liquid.

According to some embodiments of the invention the method is executed for changing turbidity of a liquid.

According to some embodiments of the invention the method is executed for varying a pH of a liquid.

According to some embodiments of the invention the method is executed for varying a redox potential of a liquid.

According to some embodiments of the invention the method is executed for varying concentration of dissolved oxygen in a liquid.

According to some embodiments of the invention the method is executed for varying specific conductivity of a liquid.

According to some embodiments of the invention the varying comprises increasing.

According to some embodiments of the invention the method is executed for disinfecting a liquid.

According to some embodiments of the invention the disinfecting comprises destroying fungal spores.

According to some embodiments of the invention the disinfecting comprises destroying bacterial spores.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of a system for treating a fluid containing foreign material, according to some embodiments of the present invention;

FIG. 1B is a schematic illustration of magnified partial view showing a first hull of the system, according to some embodiments of the present invention;

FIG. 1C is a schematic illustration of magnified partial view showing a second hull of the system, according to some embodiments of the present invention;

FIG. 2 is a transverse cross-sectional view along the line A-A of FIG. 1A, according to some embodiments of the present invention.

FIG. 3 is a transverse cross-sectional view along the line B-B of FIG. 1A, according to some embodiments of the present invention;

FIG. 4 is a schematic illustration showing flow lines over a simplified illustration of the system, according to some embodiments of the present invention.

FIG. 5 is a schematic illustration showing a plan cross-section view of an exemplified device according to some embodiments of the present invention; and

FIG. 6 is a schematic illustration showing a plan cross-section view of a circular capsule with a water inlet nozzle of an exemplified device according to some embodiments of the present invention.

### DESCRIPTION OF SPECIFIC EMBODIMENTS OF THE INVENTION

The present invention, in some embodiments thereof, relates to fluid dynamics and, more particularly, but not exclusively, to a method and system for treating fluid, such as, but not limited to, water.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present Inventor devised a technique that can be utilized to treat a fluid, such as, but not limited to, water. The treatment can include, for example, purification, reduction of pollution, and/or separation, and can be useful for increasing the efficiency of various technological processes, such as, manufacturing of components and the like. The technique of the present embodiments typically involves hydrodynamic processes, which is optionally and preferably carried out under a resonance condition. In some embodiments of the present invention the technique comprises a vortex generation stage and a flow separation stage. The stages are optionally and preferably carried out in a first segment and a second segment of a tubular structure. The separated flows can either be collected separately and discharged through separate outlets or be collected as a mixture and discharged together for further processing.

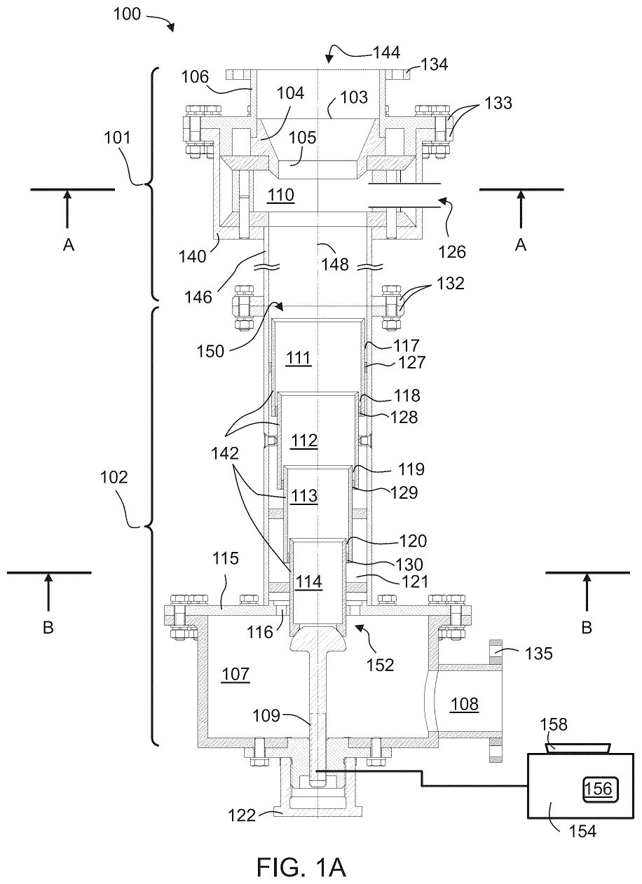

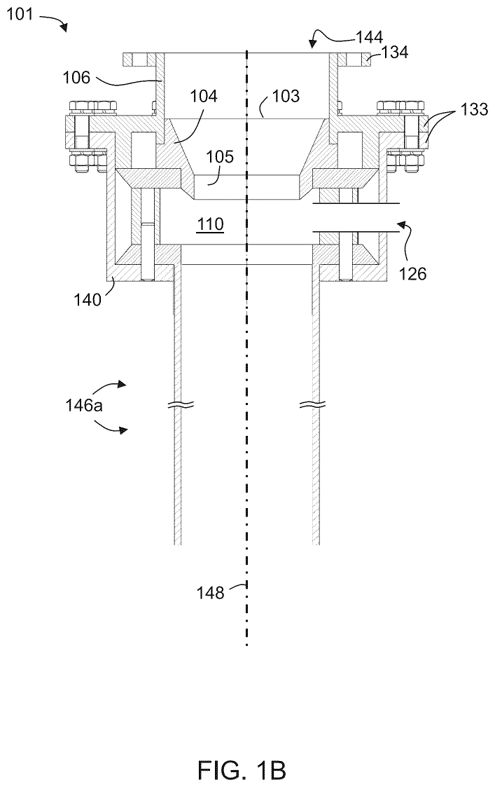

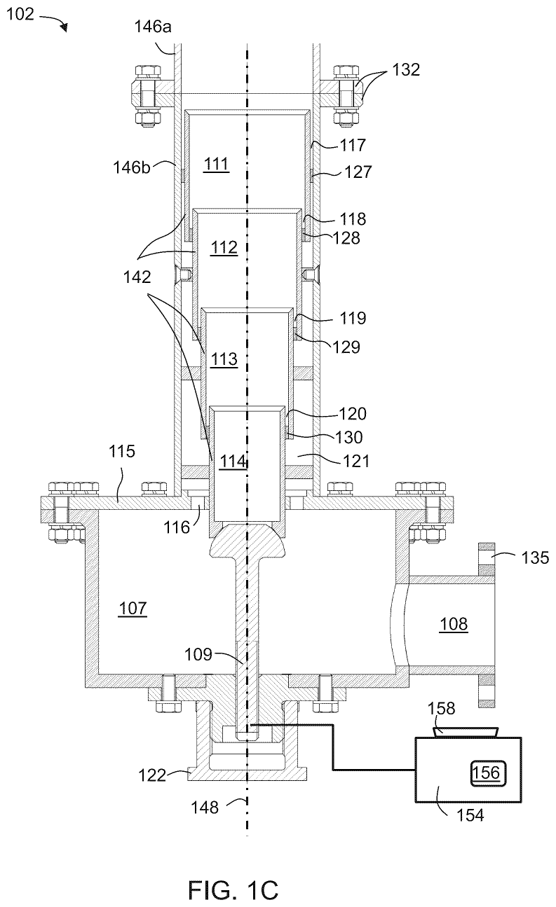

Referring now to the drawings, FIGS. 1A-C, 2, 3 and 4 illustrate a system 100 for treating a fluid containing foreign material, according to some embodiments of the present invention.

Typically, system 100 is used for separating at least a portion of the foreign material from the fluid. System 100 can be used for treating any fluid phase, such as liquid or gas, and any phase of the foreign material, including solid, liquid, and gas. In some embodiments of the present invention the fluid is a liquid, typically, but not necessarily water. In some embodiments the fluid and the foreign material form wastewater, such as, but not limited to, industrial wastewater. In some embodiments the fluid and the foreign material form seawater. In some embodiments the fluid and the foreign material form a sewage. In some embodiments the fluid and the foreign material form a drainage. In some embodiments the fluid and the foreign material form slurry or sludge. The fluid and foreign material can form any type of mixture. For example, in some embodiments of the present invention system 100 is used for treating a liquid and a foreign material in a liquid phase that forms an emulsion with the liquid; in some embodiments of the present invention system 100 is used for treating a liquid and a foreign material in a solid phase that forms a suspension with the liquid; in some embodiments of the present invention system 100 is used for treating a liquid and a foreign material in a solid phase that forms a colloid with the liquid; in some embodiments of the present invention system 100 is used for treating a liquid and a foreign material in a solid phase that forms a sol with the liquid; in some embodiments of the present invention system 100 is used for treating a liquid and a foreign material in a gaseous phase that is dissolved in the liquid; and in some embodiments of the present invention system 100 is used for treating a liquid and a foreign material that form a heterogeneous mixture. Other types of mixtures are also contemplated.

In some embodiments of the present invention the foreign material comprises an inorganic material. Representative examples of inorganic materials suitable according to some embodiments of the present invention include, without limitation, heavy metals e.g., lead, mercury, cadmium, arsenic, chromium, nickel), aluminum, nitrate, nitrite, phosphates, sulfates, chlorides, fluorides, cyanides, bromates, bromides, boric acid, and boron.

In some embodiments of the present invention the foreign material comprises an organic material. Representative examples of organic materials suitable according to some embodiments of the present invention include, without limitation, pesticides (e.g., atrazine, glyphosate, chlorpyrifos), polychlorinated biphenyls, hydrocarbons (such as, but not limited to, benzene, toluene, ethylbenzene, xylenes, aliphatic hydrocarbons, including straight-chain and branched-chain hydrocarbons, e.g., octane, pentane, hexane, gasoline, diesel fuel components, polyaromatic hydrocarbons, polycyclic aromatic hydrocarbons, chlorinated hydrocarbons, e.g., dichloromethane, chloroform, carbon tetrachloride), chlorinated solvents (e.g., trichloroethylene, perchloroethylene), pharmaceuticals, bisphenol A, phthalates, dioxins, furans, and algal toxins (e.g., microcystins, saxitoxins).

In some embodiments of the present invention the foreign material comprises a biological material or a product thereof. Representative examples of biological materials and products thereof suitable according to some embodiments of the present invention include, without limitation, bacteria (e.g.,E. coli, Salmonella, Campylobacter), viruses (e.g., norovirus, hepatitis A virus, rotavirus), parasites (e.g., giardia lamblia, cryptosporidium, entamoeba histolytica), algal blooms (e.g., toxin-producing algae), fungi, mold, protozoa, biofilms, fecal coliforms, disease-causing pathogens (e.g.,Clostridium, Vibrio, Legionella), cyanotoxins, mycotoxins, bacterial toxins, marine toxins, and endotoxins.

It is to be appreciated that system 100 can treat a fluid with more than one type of foreign material, optionally and preferably a fluid with two or more types of foreign material.

With reference to FIG. 1A, system 100 comprises an inlet 126, a swirling apparatus 110, a tapered hollow structure 142, a first outlet 144, and a second outlet 116. Inlet 126 is connected to a source (not shown) providing the mixture of fluid with the foreign material, and swirling apparatus 110 is arranged to receive the mixture. For clarity of presentation, system 100 is shown to comprise a first hull 101 and a second hull 102, wherein swirling apparatus 110 is in first hull 101 and tapered hollow structure 142 is in second hull 102. Magnified partial views of system 100, showing first 101 and second 102 hulls are shown in FIGS. 1B and 1C, respectively.

Apparatus 110 is configured to accelerate the fluid to form a helical flow of the fluid, and to induce fluid turbulence and cavitation, as further detailed hereinbelow. The helical flow is typically along more than one helix and is therefore manifested as a three-dimensional vortex having a dominant circumferential velocity component, and also an axial velocity component along a longitudinal axis 148 of system 100, which axial velocity component is directed predominantly toward the second outlet 216. In some embodiments described below, there is an additional return flow that intensifies the turbulence and cavitation. The additional return flow can also be helical, contributing to a counter vortex having a dominant circumferential velocity component and also an axial velocity component which is predominantly away from the second outlet 216, wherein the vortex and counter vortex are generally concentric with respect to each other. The vortex and turbulence centrifugally drift the foreign material toward a periphery of the vortex.

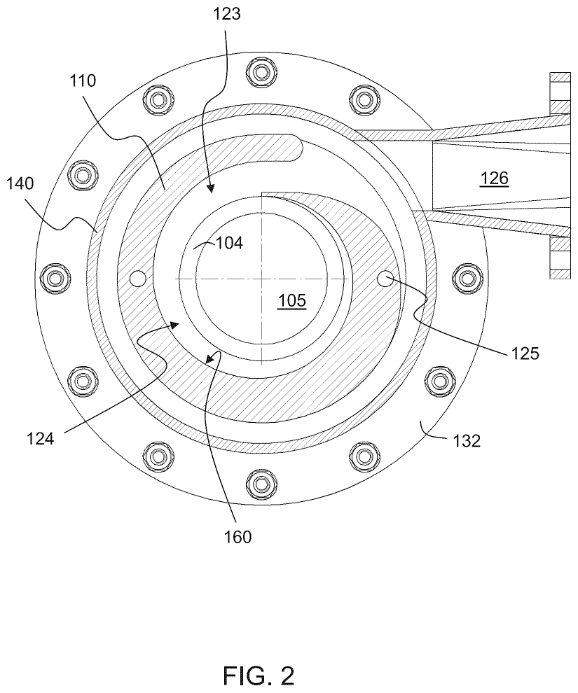

FIG. 2 is a transverse cross-sectional view along the line A-A of FIG. 1A, showing swirling apparatus 110 in greater detail. Swirling apparatus 110 is typically enclosed in a hull 140, for example, by means of screws 125 or other fixating members, and comprises a streamlined spiral surface 160 that guides and accelerates the fluid entering through the inlet 126. The spiral surface can form any type of spiral. Representative examples of spiral types suitable for the present embodiments, include, without limitation, an Archimedean spiral, a Fermat's spiral, a logarithmic spiral, a lituus spiral, and a hyperbolic spiral. In some embodiments of the present invention the spiral is an Archimedean spiral. Preferably, the acceleration is in a plane that is perpendicular to longitudinal axis 148. The fluid is accelerated preferably to increase the tangential component of the fluid velocity, with a decrease in the radial component of the velocity due to the streamlined surface of the spiral.

Hollow structure 142 has a proximal end 150 and a distal end 152, and is configured for receiving the helical flow at its proximal end 150 and separating it into an inner flow within hollow structure 142 and a peripheral flow outside hollow structure 142. Since the foreign material is drifted toward the periphery, the amount of foreign material is higher in the peripheral flow than in the inner flow. Thus, system 100 separates at least a portion of the foreign material in the mixture that enters the system through inlet 126. In some embodiments of the present invention hollow structure 142 is stepwise tapered, wherein its diameter reduces toward its distal end 152 in a series of distinct, discrete steps. Alternatively, hollow structure 142 can be tapered continuously.

The inner and peripheral flows are discharged by the outlets 144 and 116, where first outlet 144 discharges the inner flow, and second outlet 116 discharges the peripheral flow. In some embodiments of the present invention first 144 and second 116 outlets are at opposite sides of swirling apparatus 110. For example, as illustrated in FIGS. 1A and 1C, second outlet 116 can be near distal end 152 of structure 142, e.g., circumferential and co-planar with distal end 152, and outlet 144 can be provided in the form of pipe 106 mounted at a side of apparatus 110 that is opposite to tapered hollow structure 142. Pipe 106 can be connected to an external line (not shown) via a flange connector 134.

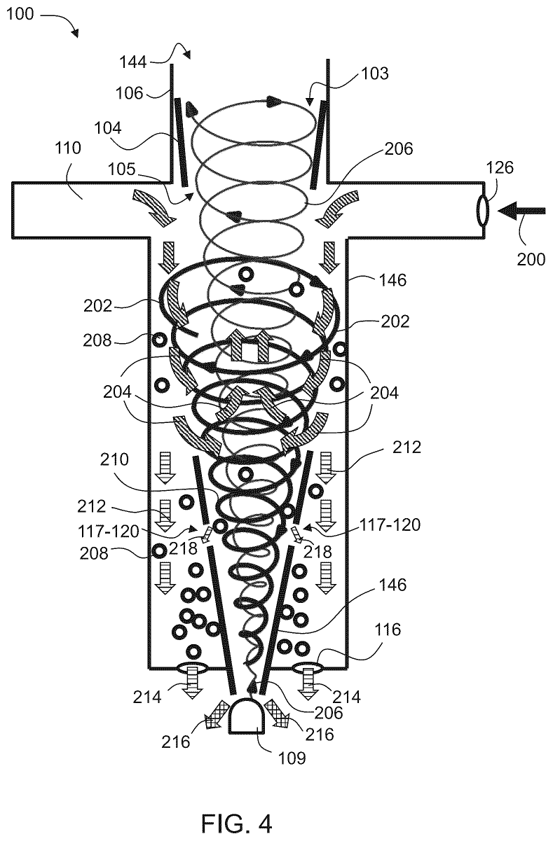

A schematic illustration showing flow lines over a simplified illustration of system 100 is provided in FIG. 4. Shown in FIG. 4 are: an inflow 200 of the mixture of fluid and foreign material through inlet 126, the helical flow 202, and the fluid turbulence 204 induced by apparatus 110. Also shown are the additional return flow 206, and the drifted foreign material 208 at the periphery of helical flow 202. Further shown are the inner flow 210 within tapered hollow structure 142, the peripheral flow 212 outside structure 142, and the outflow 214 of the peripheral flow through outlet 116.

System 100 typically comprises a tubular structure 146 that encapsulates hollow structure 142, wherein swirling apparatus 110 is arranged to feed the helical flow 202 of the fluid into tubular structure 146. Tubular structure 146 is oriented such that it share the longitudinal axis with system 100. Preferably, inlet 126 is arranged to guide the fluid from the fluid source to apparatus 110 along a direction that generally perpendicular to the longitudinal axis 148. The dimensions and shape of tubular structure 146 are optionally and preferably selected such that at least one of flows 202, 204 produced by apparatus 110 generates acoustic resonance in tubular structure 146. The Inventor found that such acoustic resonance intensifies a formation of anisotropic turbulence and pressure fluctuations, and enhances cavitation. Specifically, the acoustic resonance causes local decrease in the pressure of the liquid to a level below its vapor pressure, leading to a cavitation in the form of vapor or gas-filled cavities within the liquid. When the flow moves the cavities to regions of higher pressure within the liquid, they collapse rapidly. The collapse of these cavities generate forces and shock waves that are sufficiently high to break the molecular bonds and dissociate the molecules of the liquid and/or foreign material. For example, when the fluid is water, the water molecule H₂O can dissociate into a hydrogen ion and a hydroxide ion. The presence of these ions in the water may result in formations of hydrogen molecules and hydrogen peroxide molecules.

Preferably, but not necessarily, tubular structure 146 has a shape of a right cylinder. Other shapes, preferably shapes having round walls, are also contemplated. Tubular structure 146 is optionally and preferably manufactured from a transparent material. An advantage of this embodiment is that it allows visual inspection of the flows in structure 146, for example, to determine whether or not an acoustic resonance is generated.

With reference to FIGS. 1B and 1C, tubular structure 146 has a first segment 146a which is between apparatus 110 and tapered hollow structure 142, and a second segment 146b which encompasses tapered hollow structure 142. The length of segment 146a is denoted L1, the length of segment 146b is denoted L2, and the length of tubular structure 146 is denoted L, where L, L1, and L2 satisfy L=L1+L2. The length of tapered hollow structure 142 is typically the same or approximately the same (e.g., within a 10% tolerance) as the length of second segment 146b. Tubular structure 146 can be provided as a monolithic structure including both segments 146a and 146b as two segments of the same monolithic structure. Alternatively, segments 146a and 146b can be assembled to form tubular structure 146 has a shape. In the schematic illustration of FIG. 1C, which is not to be considered as limiting, segments 146a and 146b are connected to each other by a flange connector 132.

In some embodiments of the present invention L1 is larger than L2. A typical value for the ratio L1/L2 is from about 1.5 to about 5. The ratio L1/L2 is preferably selected based on the expected volumetric flow rate provided by the fluid source connected to inlet 126. As a representative example, in experiments performed by the Inventor for a volumetric flow rate of about 6.67×10⁻⁴ m³/s (about 2.4 m³/hour) tubular structure 146 had a shape of a right cylinder, segment 146a had a length L1 of about 0.25 meters (250 mm) and segment 146a had a length L2 of about 0.105 meters (105 mm), providing a ratio L1/L2 of about 2.38.

In some embodiments of the present invention hollow structure 142 is at least partially closed at its distal end 152, forcing return flow 206 of the fluid toward swirling apparatus 110 and opposite to the peripheral flow 212. Return flow 206 optionally and preferably passes through apparatus 110 and exits system 100 via first outlet 144, allowing first outlet 144 to be at an opposite side of swirling apparatus 110 relative to second outlet 116.

Preferably, system 100 comprises a controllable valve 109 mounted at distal end 152 in a manner that allows controlling the extend at which distal end 152 is closed. For example, when valve 109 assumes a closed state, distal end 152 is completely closed so that the fluid is prevented from exiting tapered hollow structure 142 through distal end 152. When valve 109 assumes a state other than a closed state (opened or partially opened state), a portion of the inner flow 210 exits through distal end 152 as an outflow 216, as illustrated in FIG. 4. In some embodiments, system 100 comprises a controller 154 having a circuit 156 configured for controlling valve 109 so as to select the flow rate of the fluid that is allowed to exit tapered hollow structure 142 through distal end 152. Preferably, circuit 156 automatically controls valve 109 based on a ratio between the rate of inner flow 210 and the rate of peripheral flow 212. Alternatively or additionally, valve 109 can be controlled by a user, e.g., via a user interface 158 that may, for example, be provided with controller 154.

User interface 158 may include buttons, which are activated by pressing, and may take different shapes depending on each button's particular function. User interface 158 may also include LEDs to indicate the state of vain various exemplary embodiments of the invention 109 or other elements of system 100. User interface 158 may optionally and preferably comprise a touch screen or a keyboard. User interface 158 can be mounted on controller 154, as illustrated in FIGS. 1A and 1C, or be remote to controller 154 in which case communication between interface 158 and controller 154 is established via a communication network.

With specific reference to hull 102, in some embodiments of the present invention tapered hollow structure 142 comprises a set of hollow casings. In the representative example of FIGS. 1A and 1C, which is not to be considered as limiting, structure 142 comprises four hollow casings 111, 112, 113, and 114, but it is to be understood that structure 142 can comprise any number of hollow casings. The hollow casings of structure 142 are arranged with open channels 118, 119, 120 between adjacent casings, and optionally and preferably also an open channel 117 between the first casing 111 of the set and the inner surface of tubular structure 146 (see enlarged view in FIG. 1C). Specifically for the schematic and non-limiting illustration of FIG. 1C, channel 118 is formed between the inner surface of casing 111 and the outer surface of casing 112, channel 119 is formed between the outer surface of casing 113 and the inner surface of casing 112, and channel 120 is formed between the inner surface of casing 113 and the outer surface of casing 114. Another channel 121 is formed between the inner surface of tubular structure 146 and the outer surfaces of all casings 111-114. The last casing of the set (casing 114 in the present example) is optionally and preferably docked with a lid 115, wherein the outlet 116 is formed in lid 115.

The channels 117-120 establish fluid communications between the inner flow 210 (within the casings of structure 142) and the peripheral flow 212 (outside the casings of structure 142), and are configured to guide a peripheral portion 218 of the inner flow 210 into channel 121 so as to combine peripheral portion 218 with peripheral flow 212. This configuration ensures that the amount of foreign material at the peripheral flow 212 increases toward outlet 116, as illustrated in FIG. 4.

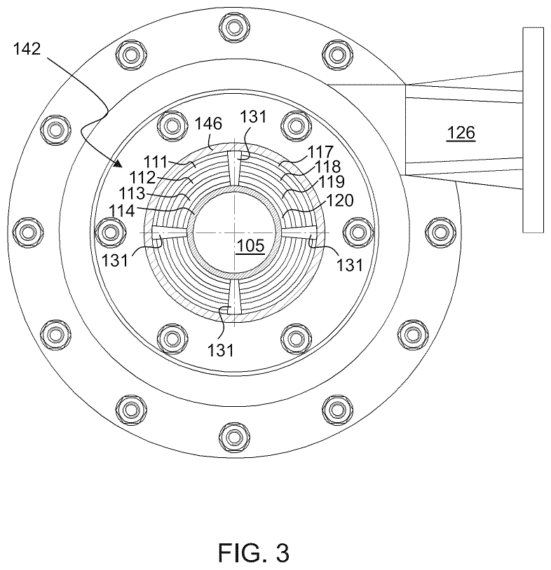

The hollow casings of structure 142 preferably form a telescopic set, with decreasing diameter away from first hull 101 and toward the distal end 152. In these embodiments each of the casings, except the first 111, is partially introduced into the interior of the preceding, larger in diameter, casing, wherein the channels are formed in the overlap region between the outer wall of smaller-diameter casing and the inner wall of the larger-diameter casing. A transverse cross-sectional view of the telescopic hollow casings 111-114, along the line B-B of FIG. 1A, is illustrated in FIG. 3. The hollow casings 111-114 are typically shaped as non-tapered cylinders, in which case structure 142 is stepwise tapered, but other shapes are also contemplated, preferably round wall shapes.

The alignment and fixation of the first casing 111 to the inner surface of second segment 146b can be carried out by means of one or more ribs 127, and the alignments and fixation of adjacent casings (111-114, in the present example) to each other can be carried out by means of one or more ribs 128, 129, and 130, respectively. The alignment and fixation of the entire set of casings that form tapered hollow structure 142 to the inner surface of to the inner surface of second segment 146b can be carried out by means of one or more ribs 131, as illustrated in the cross-sectional view of FIG. 3.

In some embodiments of the present invention system 100 comprises a container 107 in fluid communication with the outside of tapered hollow structure 142 via second outlet 116. In these embodiments, second outlet 116 discharges the peripheral flow 206 as outflow 214 (shown in FIG. 4) into container 107 (not shown in FIG. 4, see FIG. 1C). In embodiments in which valve 109 is employed, and when valve 109 is not fully closed, a portion of the inner flow exits via valve 109 as outflow 216 also into container 107. In some embodiments, valve 109 is sealed with a nut 122, screwed into a fitting attached to the bottom of container 107 having a threaded connection with stem of valve 109. Container 107 typically comprises a container outlet 108, which discharges the fluid out of container 107. Container outlet 108 can be connected to an external line (not shown) by means of a flange connector 135. Typically, the outflow 214 through outlet 116 is considered as waste, in which case container outlet 108 is connected to a drain line configured to discard waste.

Referring again to FIGS. 1A-3, system 100 optionally and preferably comprises a conical element 104 having an axial inlet opening 105 and an axial outlet opening 103, and being positioned between apparatus 110 and outlet 144. Apparatus 110 and conical element 104 can be connected to each other by means a flange connector 133, preferably arranged to ensure aligned and sealed connection.

In use of system 100, a flow of fluid containing foreign material is fed from an external source (not shown) into inlet 126, from where it enters the hull 140 of apparatus 110. Within apparatus 110, the flow is accelerated as it moves along the spiral surface 160 from a first flow section 123 to a second flow section 124, to form a swirled flow. Due to the conical shape of conical element 104 and centrifugal forces within the swirled flow, the swirled flow exiting apparatus 110 is directed primarily away from inlet 105 and is introduced into segment 146a of tubular structure 146. This creates a helical flow. The helical flow entering second segment 146b of tubular structure 146 is separated into a peripheral flow and an inner flow. The peripheral flow is guided by channel 121 between the outer surfaces of the casings of tapered structure 142 and the inner surface of second segment 146b. The inner flow is guided by the inner surfaces of the casings of tapered structure 142, and is characterized by a gradually decreasing diameter whereby the diameter is larger at the proximal end 150 than at the distal end 152 of tapered hollow structure 142. The peripheral portion of the inner flow is discharged into channel 121 through successively arranged channels 117-120, thereby joining the peripheral flow in channel 121. In embodiments in which valve 109 is employed, a return flow is generated at distal end 152. The return flow optionally and preferably passes through apparatus 110, introduced into conical element 104 via inlet 105, and is thereafter discharged via outlet 144 formed in pipe 106 for further use. When valve 109 is not completely closed, part of the inner flow is controllably discharged though the distal end 152 of tapered hollow structure 142.

Following is a description of a method suitable for treating a fluid containing foreign material, according to some embodiments of the present invention. The fluid and foreign material can be any of the aforementioned types of fluids and foreign materials. The method can be executed by a fluid treatment system, such as, but not limited to, system 100. The method accelerates the fluid by a swirling apparatus, such as, but not limited to, apparatus 110, to form a helical flow of the fluid, to induce fluid turbulence and cavitation, and to centrifugally drift foreign material toward a periphery of helical flow, as further detailed hereinabove. The method separates the helical flow into an inner flow and a peripheral flow wherein an amount of foreign material is higher in peripheral flow than in inner flow. This can be achieved by means of a by a tapered hollow structure, such as, but not limited to, structure 146 described above. The inner flow and the peripheral flow, are then discharged separately from each other, as further detailed hereinabove.

In some embodiments of the present invention the fluid containing the foreign material is fed from an external source, and is accelerated in apparatus 110 to increase the tangential component of velocity and to decrease the radial component thereof. The formed flow can then be introduced into the tubular structure 146, where a two-stage treatment of the incoming flow is performed sequentially.

In the first stage, executed within segment 146a of tubular structure 146, a twisted peripheral flow and an axial flow are formed, moving in countercurrent with axial velocities, in a field with a radial static pressure gradient. The formation of such a flow structure leads to emergence of anisotropic turbulence prevailing along the radius, the induction of acoustic pressure oscillations in the flows, and the generation of intensive cavitation, which significantly affects the change in the physical and chemical properties of the flows.

Due to the effect of cavitation, during collapses of vapor bubbles, there is an increase in temperature and pressure in the central region of the cavitation bubble. As a result, intermolecular bonds break, especially in long molecules. When the liquid is water, the axial flow is saturated with positively charged hydrogen ions H⁺, forming H₂, and the peripheral flow is saturated with negatively charged ions OH⁻, forming H₂O₂. In this case, the axial flow is a reducing flow, and the peripheral flow is an oxidizing flow.

In the zone of axial flow formation, a bundle-shaped flow can be formed. This bundle-shaped flow can comprise a mixture of gas, vapor and liquid droplets, and can be formed in a zone facing away from apparatus 110 with a shape of an inlet funnel a gradually reduced diameter, whereby the diameter is larger at the proximal end 150 than at the distal end 152 of tapered hollow structure 142.

An intensification of hydrodynamic processes are optionally and preferably achieved by creating a resonant flow regime in segment 146a of tubular structure 146. The present embodiments contemplate one or more, more preferably two or more, more preferably each, of the following intensification processes within segment 146a: intensification of anisotropic turbulence formation, intensification of acoustic pressure fluctuations in the flows, and intensification of cavitation generation.

The presence of the resonance mode can be verified by visual detection (in case in which tubular structure 146 is transparent) of the presence of a harness in the axial flow consisting of a mixture of gas, vapor and dripping liquid, with the formation of a funnel at the inlet to the second hull. The presence of the resonance mode can also be verified by detecting amplification of acoustic oscillations of sound frequencies. The presence of the resonance mode can also be verified by detecting changes in the physical and chemical properties of the fluid in the exit flow or the peripheral flow.

The return flow can be withdrawn through apparatus 110 into axial inlet opening 105 of conical element 104 and then to exit through outlet 144 for further use or processing. The peripheral flow is introduced into the second hull of the vortex tube. The flow at proximal end 150 of tapered hollow structure 142 is divided into the peripheral and inner flows, as further detailed hereinabove. The velocities of these flows optionally and preferably change as they move within segment 146b toward the outlet 116 and distal end 152. The inner flow optionally and preferably experiences a decrease in its diameter in the direction of the distal end 152. The peripheral flow is formed from the peripheral portion of the inner flow, which is discharged through successively arranged channels 117-120.

According to some embodiments of the present invention the method comprises controlling the ratio between the flow rates of the peripheral flow and the inner flow. This can be achieved by controlling the state of valve 109, as further detailed hereinabove.

The process within segment 146b of tubular structure 146 provides a hydrodynamic separation of components of the fluid and foreign material according to densities. This allows solids, synthesized salts, oxides and/or other components to be removed from the fluid. By controlling the flow ratio, the hydrodynamic separation can be optimized.

The technique discovered by the Inventor is therefore useful for separating water. In a method contemplated according to some embodiments of the present invention a flow of water is generated while inducing cavitation therein. The flow can be generated by forming a vortex in a tubular structure, such as, but not limited to, tubular structure 146, or by any other technique or combination of techniques that are known to induce cavitation in the water. Preferably, the flow is generated under resonance conditions within the tubular structure. The generated flow causes local decrease in the pressure of the water to a level below its vapor pressure, leading to a cavitation in the form of vapor or gas-filled cavities within the water. When the flow moves the cavities to regions of higher pressure within the water, they collapse rapidly. The collapse of these cavities generate forces and shock waves that are sufficiently high to break the covalent bonds of the water molecules and dissociate them into hydrogen ions and hydroxide ions.

Thus, the generated flow provides an ion-enriched water flow, which comprises at least hydrogen ions and hydroxide ions. The ion-enriched water flow is then separated into a first secondary water flow and a second secondary water flow that are physically separated from each other. The separation is done in a manner that the amount of hydrogen ions is higher in the first secondary water flow than in the second secondary water flow, and the amount of hydroxide ions is higher in the second secondary water flow than in the first secondary water flow. Preferably, the second secondary flow is peripheral to the first secondary flow. The separation can be, for example, by means of a tapered hollow structure, such as, but not limited to, tapered hollow structure 142. Optionally and preferably, the tapered hollow structure comprises a set of hollow casings (such as, but not limited to, casings 111-114), arranged with open channels between adjacent casings, as further detailed hereinabove. The method therefore separates the water into two flows of different polarities. Typically, the presence of high concentration of hydrogen ions in the first secondary flow may ultimately result in the formation of hydrogen molecules, and the presence of high concentration of hydroxide ions may ultimately result in the formation of hydrogen peroxide molecules.

The techniques described above can be utilized for many processes. Representative examples include, without limitation, changing a color or transparency of a liquid such as, but not limited to, an aqueous liquid, changing turbidity of a liquid such as, but not limited to, an aqueous liquid, varying (e.g., increasing) a pH of a liquid such as, but not limited to, an aqueous liquid, varying (e.g., increasing) a redox potential of a liquid such as, but not limited to, an aqueous liquid, varying (e.g., increasing) concentration of dissolved oxygen in a liquid such as, but not limited to, an aqueous liquid, varying (e.g., increasing) specific conductivity of a liquid such as, but not limited to, an aqueous liquid, and disinfecting a liquid such as, but not limited to, aqueous liquid.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### Examples

Reference is now made to the following examples, which together with the above descriptions illustrate some embodiments of the invention in a non limiting fashion.

This example describes a water treatment device. The exemplified device can provide solution for several problems that will be discussed below. It can achieve a final result that provides a more economically viable water purifier with savings on energy and less loss of water. The exemplified device provides advantages in comparison with the means known and used for the same purposes in the current state of the art.

Water is not only an essential resource for life; it is also used in countless daily actions such as food preparation, cleaning, etc. For this reason, much emphasis has been placed of late on taking care of this limited resource.

Water is a vital resource for human beings, not only for consumption, but also for all types of industrial processes and production of goods.

Water treatment is increasingly necessary due to the scarcity of drinking water and the growing needs of the world's population.

Of the total water on the planet, only 2.5% is fresh water, and only 0.4% of that amount is water suitable for human consumption.

Human activities alter the natural state of water and pollute it, causing serious environmental damage to rivers and seas and making it impossible to use it for activities such as agriculture. That is why it is essential to ensure proper water treatment in order to reuse it and return it to the environment.

Water treatment is currently a process involving different types of operations, given that there are physical, chemical, physical-chemical or biological treatments whose purpose is to eliminate or reduce water pollution or undesirable characteristics.

The aim of this process is to obtain water with the appropriate characteristics for its intended use.

Therefore, the water treatment process varies depending on the initial properties of the water and also its final use.

The exemplified device is capable of obtaining water with the appropriate characteristics for the intended use using only a physical process.

The exemplified device eliminates or reduces a series of processes that are currently being used such as coagulation-flocculation, decantation, water disinfection, biological treatments or the elimination of pathogens.

As a consequence, it provides benefits like energy savings, less pollution, less water loss, and it is more economically viable.

In addition, the exemplified device makes it possible to create portable plants for any volume of water treatment, such as, for example, the treatment of wastewater from urban or industrial centers.

The exemplified device resolves the problems explained above, without affecting any of its benefits in other aspects.

The exemplified device provides an economical, ecological, practical, simple and easy-to-use solution, resulting in water treatment without disinfectant reagents.

The exemplified device has aspects differentiating it from the current state of the art and provides a number of advances in already known elements with their corresponding advantages.

In particular:
Water with the appropriate characteristics is obtained solely through a physical process.
Processes such as decantation, biological treatments, pathogen removal, etc. are eliminated or reduced.
Energy is saved and less pollution is produced.
It provides the possibility of portable treatment plants for any volume.
Less water loss.
It is environmentally friendly because it does not require electrical power to operate.

Following is a description of the components of the exemplified device. A hollow tubular casing that has a circular capsule at one end with a water inlet nozzle whose distal end is larger in diameter than the proximal end. This capsule is appropriately supported by means of a perimeter support and houses a fixed swirling piece inside. The capsule has a hollow internal surface connected to the interior of the tubular casing, and a hollow external surface connected to a purified water discharge outlet. Inside the hollow tubular casing, towards the end opposite the circular capsule, there is an inner telescopic tube divided into zones whose diameters decrease as it nears that end, with perimeter openings at the junctions between zones. There is a tank with an outlet nozzle at the opposite end of the circular capsule and this tank houses a central valve placed lengthwise in regard to the tubular casing.

Following is a description of the operation of the exemplified device. A flow of water is introduced from an external source through the inlet nozzle of the circular capsule, reaching the swirling piece, causing the flow of water to accelerate and become a strongly swirling flow. that moves towards the interior of the tubular casing until it reaches the telescopic inner tube whose diameter narrows as it reaches the end of the tubular casing where the central valve is located. Due to the effects inherent to cavitation and the characteristics of the invention, unwanted waste is separated from the water by swirling around the perimeter. This waste falls through the openings in the interior telescopic tube to the tank with an outlet nozzle, while the water moves through the center of the tubular casing towards the end where the valve is located, and returns again, this time already purified, towards the end where the circular capsule is located, passing through it and exiting first through its external face and then through the purified water discharge outlet.

The proposed invention involves the purification of water that contains gaseous components, solid components, biological components, and mixtures of water with hydrocarbons, and it can be used in water purification systems in municipal utilities and chemical, oil, and other refineries.

The exemplified device intensifies the cleaning process, reduces the burden on the environment and increases the efficiency of technological processes in various types of production, thereby expanding the scope of its application. The exemplified device intensifies the hydrodynamic processes by creating a resonant flow regime with the formation of a beam in an axial flow consisting of a mixture of gas, steam and dripping liquid, taking the form of a funnel when it reaches the inner telescopic tube.

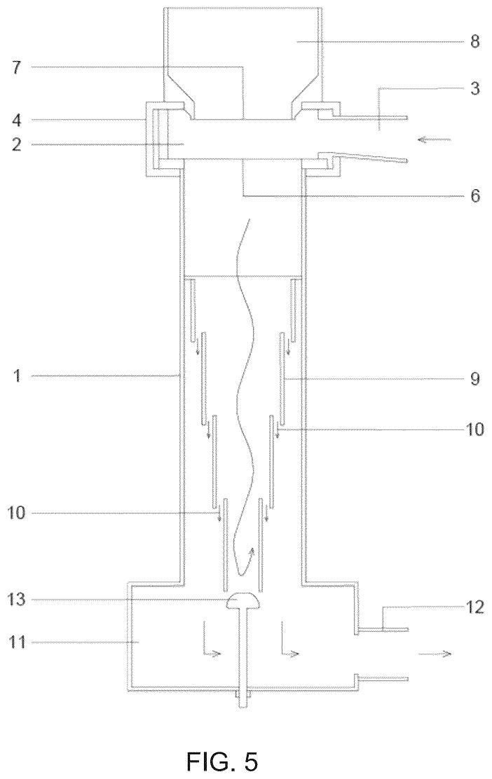

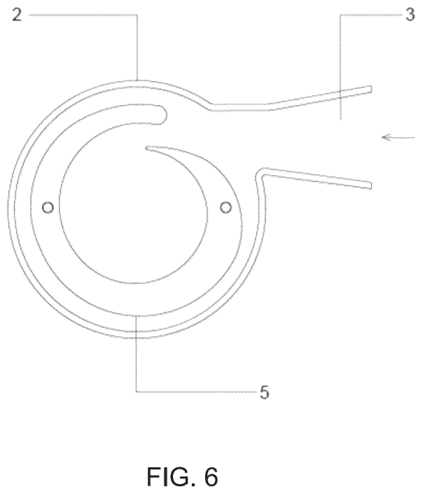

With reference to FIGS. 5 and 6, FIG. 5 is a schematic illustration showing a plan cross-section view of the exemplified device, and FIG. 6 is a schematic illustration showing a plan cross-section view of a circular capsule with a water inlet nozzle of the exemplified device.

The following numbered elements are included in FIGS. 6 and 6:
(1) Tubular casing
(2) Circular capsule
(3) Water inlet nozzle
(4) Perimeter support for the circular capsule
(5) Fixed swirling piece
(6) Internal surface of the circular capsule
(7) External surface of the circular capsule
(8) Purified water discharge outlet
(9) Telescopic inner tube
(10) Perimeter openings of the telescopic inner tube
(11) Tank
(12) Tank outlet nozzle
(13) Central valve

A preferred embodiment of the exemplified device involves the following elements: a hollow tubular casing (1) that has a circular capsule (2) at one end with a water inlet nozzle (3) whose distal end is larger in diameter than the proximal end. This capsule (2) is appropriately supported by means of a perimeter support (4) and houses a fixed swirling piece inside (5). The capsule has a hollow internal surface (6) connected to the interior of the tubular casing (1), and a hollow external surface (7) connected to a purified water discharge outlet (8). Inside the hollow tubular casing (1), towards the end opposite the circular capsule (2), there is an inner telescopic tube (9) divided into zones whose diameters decrease as it nears that end, with perimeter openings (10) at the junctions between zones. At the opposite end from the circular capsule (2), there is a tank (11) with an outlet nozzle (12) and this tank houses a central valve (13) placed lengthwise in regard to the tubular casing (1).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A system for treating a fluid containing foreign material, the system comprising:
a swirling apparatus configured to accelerate the fluid to form a helical flow of the fluid, to induce fluid turbulence and cavitation, and to centrifugally drift said foreign material toward a periphery of said helical flow;
a tapered hollow structure configured for separating said helical flow into an inner flow within said hollow structure and a peripheral flow outside said hollow structure, wherein an amount of said foreign material is higher in said peripheral flow than in said inner flow;
a first outlet configured to discharge said inner flow; and
a second outlet configured to discharge said peripheral flow.

2. The system according to claim 1, wherein said swirling apparatus is configured to impart planar acceleration.

3. The system according to claim 1, comprising a tubular structure, wherein said swirling apparatus is arranged to feed said helical flow of the fluid into said tubular structure, and wherein at least one of said flows generates a resonance in said tubular structure.

4. The system according to claim 3, comprising an inlet arranged to guide the fluid from a fluid source to said swirling apparatus along a direction generally perpendicular to a longitudinal axis of said tubular structure.

5. The system according to claim 1, wherein said hollow structure is at least partially closed at a distal end thereof, forcing a return flow of the fluid toward said swirling apparatus and opposite to said peripheral flow, wherein said first and said second outlets are at opposite sides of said swirling apparatus.

6. The system according to claim 5, comprising a controllable valve for said at least partially closure of said distal end.

7. (canceled)

8. The system according to claim 1, wherein said second outlet is circumferential and co-planar with a distal end of said hollow structure.

9. The system according to claim 1, wherein said tapered hollow structure comprises a set of hollow casings arranged telescopically with open channels between adjacent casings establishing fluid communications between said inner and said peripheral flows, so as to guide a peripheral portion of said inner flow via said channels to join said peripheral flow.

10. The system according to claim 9, wherein said hollow casings are shaped as non-tapered cylinders.

11-12. (canceled)

13. A method of treating a fluid containing foreign material, the method comprising feeding the fluid containing foreign material into a fluid treatment system and receiving from said fluid treatment system two separate fluid flows containing unequal amounts of the foreign material, wherein the fluid treatment system comprises the system according to claim 1.

14. A method of treating a fluid containing foreign material, the method comprising:
by a swirling apparatus, accelerating the fluid to form a helical flow of the fluid, to induce fluid turbulence and cavitation, and to centrifugally drift said foreign material toward a periphery of said helical flow;
by a tapered hollow structure, separating said helical flow into an inner flow within said hollow structure and a peripheral flow outside said hollow structure, wherein an amount of said foreign material is higher in said peripheral flow than in said inner flow; and
discharging said inner flow separately from said peripheral flow.

15. The method according to claim 14, wherein said accelerating by said swirling apparatus is planar.

16. The method according to claim 14, wherein said flows are formed within a tubular structure, and wherein at least one of said flows generates a resonance in said tubular structure.

17. (canceled)

18. The method according to claim 14, wherein said hollow structure is at least partially closed at a distal end thereof, forcing a return flow of the fluid toward said swirling apparatus and opposite to said peripheral flow, wherein said discharge of said inner and said peripheral flows is at opposite sides of said swirling apparatus.

19-20. (canceled)

21. The method according to claim 14, wherein said tapered hollow structure comprises a set of hollow casings arranged telescopically with open channels between adjacent casings of said set establishing fluid communications between said inner and said peripheral flows, and wherein the method comprises guiding a peripheral portion of said inner flow via said channels to join said peripheral flow.

22. (canceled)

23. The method according to claim 14, wherein said discharge of said peripheral flow is into a container.

24-34. (canceled)

35. A method of separating water, comprising:
generating a flow in the water while inducing cavitation therein, thereby providing an ion-enriched water flow comprising at least hydrogen ions and hydroxide ions; and
separating said ion-enriched water flow into a first secondary water flow physically separated from a second secondary water flow, wherein an amount of hydrogen ions is higher in said first secondary water flow than in said second secondary water flow, and wherein an amount of hydroxide ions is higher in said second secondary water flow than in said first secondary water flow.

36. The method according to claim 35, wherein said generating said flow comprises generating a three-dimensional vortex.

37. The method according to claim 35, wherein said second secondary flow is peripheral to said first secondary flow.

38. The method according to claim 13, being executed for at least one of: changing a color or transparency of a liquid, changing turbidity of a liquid, varying a redox potential of a liquid, varying concentration of dissolved oxygen in a liquid, varying specific conductivity of a liquid disinfecting a liquid, and disinfecting a liquid.

39-50. (canceled)
